(19) United States
(12) Patent Application Publication
(10) Pub. No.: US 2007/0055670 A1
(43) Pub. Date: Mar. 8, 2007

(54) System and method of extracting knowledge from documents

(76) Inventors: Higinio Oliver Maycotte, Austin, TX (US); Anne-Marie Palacios Guerra Currie, Austin, TX (US); Scott Walter Diedrick, Austin, TX (US); Zhongjian Liu, Austin, TX (US); Michael James Alletto, Austin, TX (US); James Kepper Lagarde JR., Austin, TX (US)

Correspondence Address: TOLER SCHAFFER, LLP, 5000 PLAZA ON THE LAKES, SUITE 265, AUSTIN, TX, 78746, US

(21) Appl. No.: 11/218,935

(22) Filed: Sep. 2, 2005

(51) Int. Cl. G06F 17/30

(52) U.S. Cl. 707/10

(57) ABSTRACT

A method of managing documents is provided and includes receiving a plurality of documents, normalizing each of the plurality of documents, and categorizing each of the plurality of documents to identify a document type. Further, the method includes selecting at least one automated text-based document analyst from a library system based on the document type.

### FIELD OF THE DISCLOSURE

The present disclosure relates to document analysis.

### BACKGROUND

Document management and analysis is an important component of business and research. For example, in business, the ability to manage and quickly assess a large amount of documents can reduce the costs associated with conducting business. In research, the ability to manage and assess a large amount of documents can allow researchers to quickly generate usable empirical data.

In some cases, human operators can manually review documents and retrieve key pieces of information from the documents. Alternatively, attempts have been made to create systems that use natural language processing (NLP) to “read” documents and “understand” those documents. Human operators can be extremely accurate, but also extremely slow and expensive. NLP systems are faster than humans, but accuracy is diminished. Further, NLP systems typically “read” entire documents and attempt to extract meaning from the entire document. As such, as the number of documents input to an NLP system increases, NLP systems become slower.

### BRIEF DESCRIPTION OF THE DRAWINGS

FIG. 1 is a block diagram representing a system for analyzing documents;

FIG. 2 is a block diagram representing a system for generating document analysis tools;

FIG. 3 is a flow chart illustrating a method of analyzing documents;

FIG. 4 is a flow chart illustrating a method of generating document analysis tools;

FIG. 5 is a first portion of a source document that can be input to the system for analyzing documents of FIG. 1;

FIG. 6 is a second portion of the source document;

FIG. 7 is a third portion of the source document;

FIG. 8 is a knowledge bundle that can be output by the system for analyzing documents of FIG. 1; and

FIG. 9 is a user interface for accessing knowledge bundles.

### DETAILED DESCRIPTION OF THE DRAWINGS

A system and method of managing documents is disclosed. The method includes receiving a plurality of documents, normalizing each of the plurality of documents, and categorizing each of the plurality of documents to identify a document type. Examples of document types include contracts and medical records. Further, the method includes selecting at least one automated text-based document analyst from a library stem based on the document type.

In a particular embodiment, the library system includes at least a first automated text-based document analyst associated with a first document type and at least a second automated text-based document analyst associated with a second document type. Further in a particular embodiment, the method includes extracting data and associated fields from each of the plurality of documents using the at least one automated text-based document analyst and creating a knowledge bundle from the data and associated fields.

Additionally, in a particular embodiment, the method includes outputting the knowledge bundle, storing the knowledge bundle in a database, and providing access to the database using a user interface or a client application. Further, in a particular embodiment, the documents are normalized by converting each document into a standard format.

In a particular embodiment, the system for analyzing a plurality of documents includes a normalization module and a categorization module that is coupled to the normalization module. Also, the system includes a text-based document analyzer that is coupled to the categorization module. Moreover, the system includes a library system that is coupled to the text-based document analyzer. The library system includes at least a first automated text-based document analyst associated with a first document type and at least a second automated text-based document analyst associated with a second document type.

In still another embodiment, the system for analyzing a plurality of documents includes a library system that is embedded within a computer readable medium. The library system includes at least a first automated text-based document analyst associated with a first document type and at least a second automated text-based document analyst associated with a second document type. Additionally, the first automated text-based document analyst and the second automated text-based analyst have a precision rate that is greater than eighty five percent.

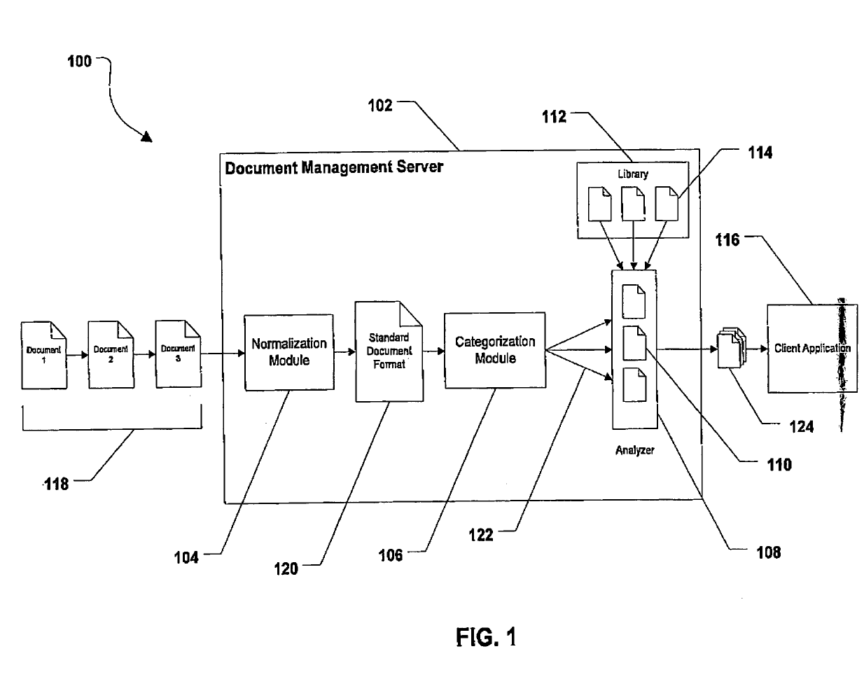

Referring to FIG. 1, a document analysis system is shown and is generally designated 100. As illustrated, the system 100 includes a document analysis server 102. As shown, the document analysis server 402 includes a normalization module 104 that is coupled to a categorization module 106. Further, the categorization module 106 is coupled to an analyzer 108 that includes one or more automated text-based document analysts 110. FIG. 1 also indicates that a library 112 can be coupled to the analyzer 108. In a particular embodiment, the library 112 includes one or more automated text-based document analysts 114. As further illustrated in FIG. 1, a client application 116 can be used to communicate with an output from the document analysis server 102.

In a particular embodiment, a plurality of source documents 118 to be automatically analyzed is fed into the normalization module 104. The normalization module 104 converts the documents into a standard document format 120. For example, the standard document format 120 may be xdoc. In a particular embodiment, the output from the normalization module 104 is fed into the categorization module 106. The categorization module 106 can output one or more categories associated with the source documents 118. In an illustrative embodiment, the categorization module 106 can determine the different categories associated with the source documents 118. In an alternative illustrative embodiment, the normalization module 104 can determine the category of each document while it is normalizing the documents. Further, the normalization module 104 can assign a category to each document and the categorization module can “read” the category of each document as each document is received at the categorization module 106.

Based on the categories assigned to the documents, the analyzer 108 receives an identified document type and can select one of a set of automated text-based document analysts 110 within the analyzer 108 to use to process the documents received at the document analysis server 102. If the analyzer 108 does not include an appropriate text-based document analyst 110 for the identified document type, the analyzer 108 can retrieve one or more alternate automated text-based document analysts 112 from the library 114. After processing the documents, the analyzer outputs a knowledge bundle 124 that may be stored or communicated to the client application 116. In an exemplary non-limiting embodiment, the knowledge bundle 124 can include information gleaned from the source documents 118 using the analyzer. Further, in a particular embodiment, the source documents 118 can be contracts, medical files, clinical files, insurance files, and government files.

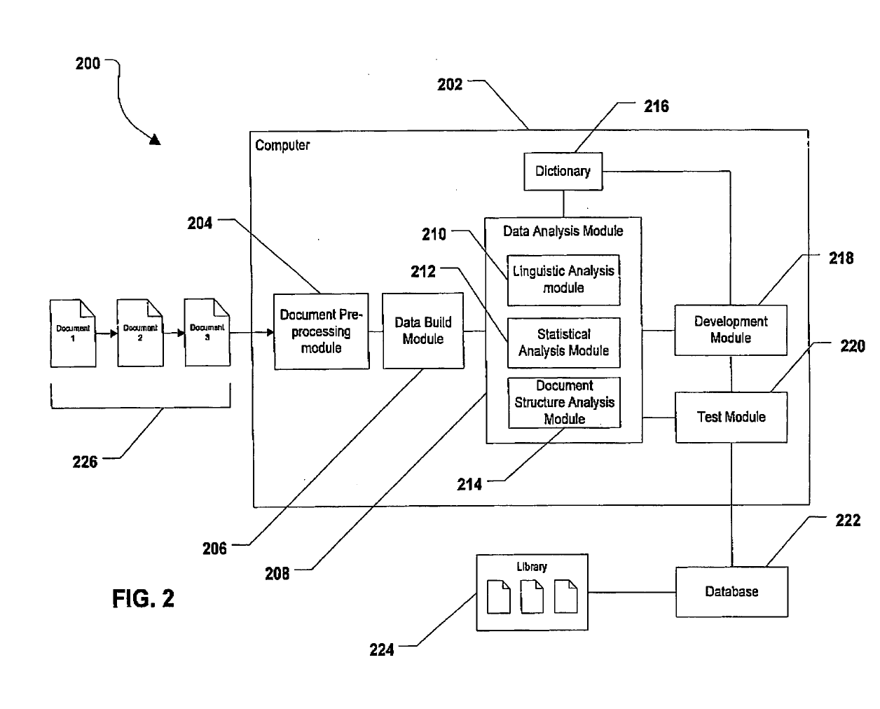

FIG. 2 illustrates an automated text-based document analyst generation system that is generally designated 200. As shown in FIG. 2, the system 200 includes a computer system 202. In a particular embodiment, the computer system 202 includes a document pre-processing module 204 that is coupled to a data build module 206. Further, a data analysis module 208 is coupled to the data build module 206. In an exemplary, non-limiting embodiment, the data analysis module 208 includes a linguistic analysis module 210, a statistical analysis module 212, and a document structure analysis module 214.

In a particular embodiment, the linguistic analysis module 210 a linguistic analysis that can include at least one of the following: a lexical analysis, a semantic analysis, a pragmatic analysis, a syntactic analysis, and a discourse analysis. Further, in a particular embodiment, the statistical analysis module 212 performs a statistical analysis that includes at least one of the following: a lexical frequency analysis and a clustering analysis. Additionally, in a particular embodiment, the document structure analysis module 214 performs a document structure analysis that includes at least one of the following: a section analysis, a table structure analysis, a document format analysis, and a document level discourse analysis.

As illustrated in FIG. 2, the computer system 202 further includes a dictionary 216 that may be used with the data analysis module 208. Also, a development module 218 is responsive to the data analysis module 208 and the dictionary 216. A test module 220 is coupled to the data analysis module 208 and to a database 222. Further, a library system 224 is coupled to the database 222. As shown, the database 222 and the library system 224 can include one or more text-based document analyst 226 generated by the system 200.

In a particular embodiment, a plurality of source documents can be input to the document pre-processing module 204. The document pre-processing module 204 can normalize the source documents and output a plurality of normalized documents having a standard format to the data build module 206. Further, the data build module 206 “reads” the standardized source and the data analysis module 208 analyzes information from the data build module 206 in order to perform a linguistic analysis, a statistical analysis, and/or a document structure analysis in order to determine whether the source documents include data patterns that can allow automated text-based document analysts generated by the system 200 to efficiently extract knowledge from the source documents.

In a particular embodiment the linguistic analysis can be performed in order to determine whether the source documents include targeted data or variations on the targeted data. Further, the statistical analysis can be performed in order to determine the frequency that particular terms appear in the source documents. Additionally, the document structure analysis can be performed in order to determine whether the source documents include a structure, e.g., headers or section titles, that will allow the automated text-based document analysts generated by the system 200 to quickly and efficiently extract knowledge or data from the source documents. For example, if the source documents include a common layout or common structural characteristic, e.g., a particular header entitled “Patient Name,” the automated text-based document analysts can located the phrase “Patient Name” and then, “read” the succeeding text in order to extract a patient's name.

The data analysis module 208 can output the patterns that it identifies to the development module 218 which can be used to develop the automated text-based document analysts for the source documents. For example, the development module 218 can be used to program search algorithms based on the patterns identified by the data analysis module 208. Additionally, the development module 218 can modify the search algorithms based on client specifications, e.g., for targeted data formats or for targeted data extraction. Also, the development module 218 can incorporate, or otherwise, apply a set of normalization rules based on a client specification.

In a particular embodiment, the development module 218 can output a pre-production automated text-based document analyst to the test module 220. The test module 220, in turn, can test the pre-production automated text-based document analyst based on a random sampling of the source documents. When a pre-production automated text-based document analyst, is deemed acceptable by the test module 220, it is converted into a production automated text-based document analyst and the production automated text-based document analyst can be stored in the database 222 or uploaded to a library 224. Otherwise, the pre-production automated text-based document analyst is modified and returned to the data analysis module 208 in order to increase the accuracy of the pre-production automated text-based document analyst.

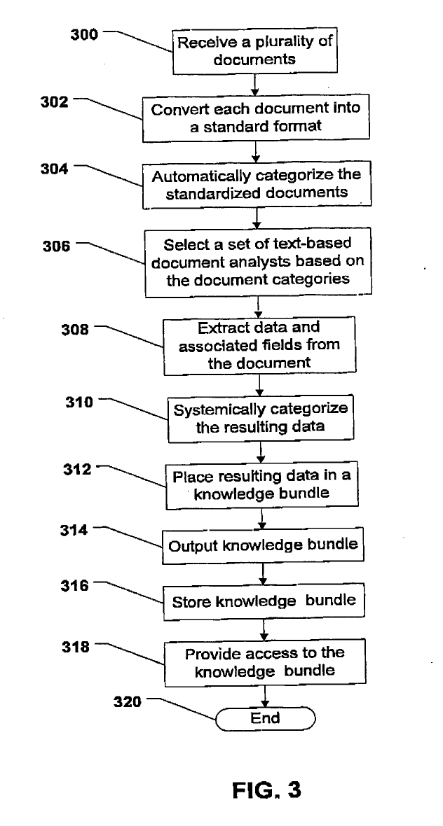

Referring to FIG. 3, a method of processing documents is shown and commences at block 300. In a particular embodiment, the method illustrated in FIG. 3 can be performed by the system 100 shown in FIG. 1. At block 300, a document analysis server receives a plurality of documents that include text strings. Thereafter, at block 302, the document analysis server converts each document into a standard format, e.g., xdoc. Moving to block 304, the document analysis server automatically categorizes the standardized documents. Further, at block 306, the document analysis server selects a set of automated text-based document analysts in order to analyze the source documents. In a particular embodiment, the selection can be based on the document categories or an identified document type. In another embodiment, the selection can be based on one or more specified contexts.

In a particular embodiment, the document type can be determined by a document analysis server, e.g., by “reading” each document. Alternatively, the document type can be input to the server as each document is scanned an input to the document analysis server.

Proceeding to block 308, the document analysis server extracts a plurality of data and associated fields from the standardized source documents. At block 310, the document analysis server systemically categorizes the resulting data extracted from the standardized source documents. At block 312, the document analysis server places the resulting data in a knowledge bundle. Moving to block 314, the document analysis server outputs the knowledge bundle. At block 316, the knowledge bundle is stored, e.g., within a database. Continuing to block 318, access is provided to the knowledge bundle, e.g., via a computer based user interface, e.g., a web interface, or by a client application. The method ends at state 320.

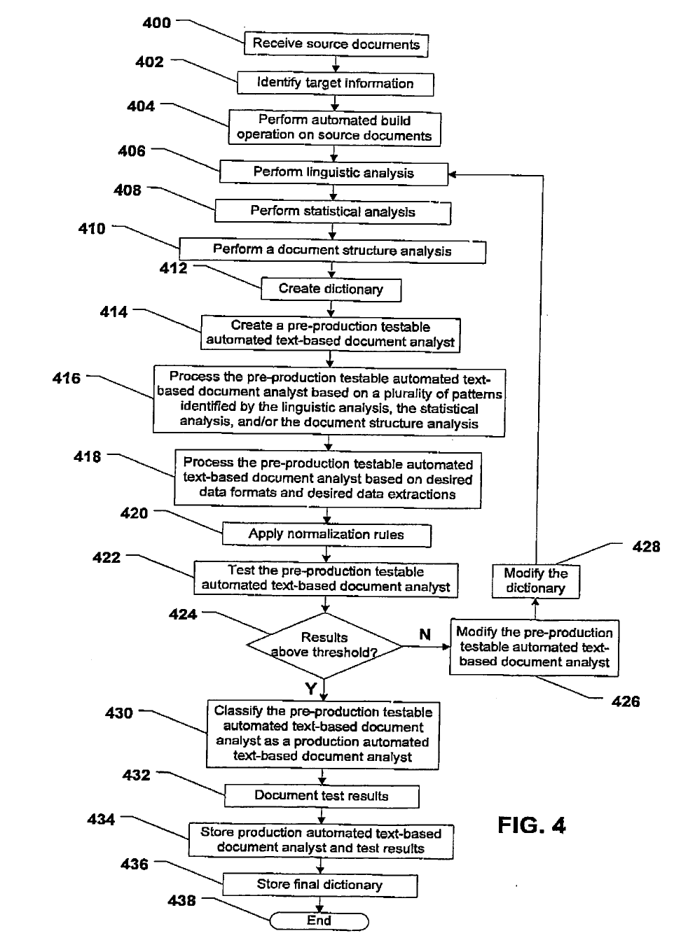

FIG. 4 illustrates a method of generating an automated text-based document analyst. In a particular embodiment, the method depicted in FIG. 4 may be performed by the system 300 illustrated in FIG. 3. Beginning at block 400, a plurality of source documents is received, e.g., at the computer. At block 402, target information within the source documents is identified. Moving to block 404, an automated build operation is performed on the plurality of source documents. Next, at block 406, a linguistic analysis is performed. For example, the linguistic analysis can include lexical analysis, a semantic analysis, a pragmatic analysis, a syntactic analysis, and/or a discourse analysis

Proceeding to block 408, a statistical analysis is performed. In a particular embodiment, the statistical analysis includes a lexical frequency analysis and a clustering analysis. At block 410, a document structure analysis is performed. In a particular embodiment, the document structure analysis can include at least one of the following: a section analysis, a table structure analysis, a document format analysis, and a document level discourse analysis.

Continuing to block 412, a dictionary is generated based on freely available reference dictionaries and based on client supplied information. For example, the dictionary can draw on dictionaries within the Universal Medical Language System (UMLS) for medical reports. Moving to block 414, the computer creates a pre-production automated text-based document analyst. In a particular embodiment, the pre-production automated text-based document analyst may be used for testing and during development. Further, in a particular embodiment, a data analysis module creates the pre-production automated text-based document analyst. At block 416, the pre-production automated text-based document analyst is further developed and processed based on a plurality of patterns identified by the linguistic analysis, the statistical analysis, and the document structure analysis. Thereafter, at block 418, the pre-production automated text-based document analyst is further developed and processed based on desired data formats and desired data extractions.

At block 420, a plurality of normalization rules are applied to the pre-production, automated text-based document analyst. In a particular embodiment, a development module can apply the normalization rules to the pre-production automated text-based document analyst. Moving to block 422, the pre-production automated text-based document analyst is tested, e.g., using a test module within the computer. In an exemplary, non-limiting embodiment, the test result provides a performance metric, e.g., an accuracy rate or a precision rate, that indicates how precisely the pre-production automated text-based document analyst extracts data from a group of test documents, e.g., the source documents. For example, if the group of documents includes one hundred actual instances of the word “smoker” or variations thereof such as, “smokes,” “tobacco use,” etc., and the pre-production automated text-based document analyst retrieves eighty-five of those instances, the accuracy, or precision, rate would be eight-five percent (85%). In a particular embodiment, the group of test documents are substantially randomly selected from the source documents.

At decision step 424, the test module determines whether the test results are above a threshold. For example, the test module can determine whether the precision rate is above eighty percent (80%), eighty-five percent (85%), ninety percent (90%), or ninety-five percent (95%). If the test results are not above the threshold, the method proceeds to block 426 and the pre-production automated text-based document analyst is modified. Thereafter, at block 428, the dictionary associated with the pre-production automated text-based document analysis is also modified. For example, if the dictionary does not include “tobacco use” as a matching term for “smoker,” “tobacco use” can be added to the dictionary.

Thereafter, the method returns to block 406 and continues as shown in FIG. 4. At decision step 424, when the test results are above the threshold, the method moves to block 430 and the pre-production automated text-based document analyst is classified as a production automated text-based document analyst. At block 432, the test results are documented. Next, at block 434, the production automated text-based document analyst and the documented test results are stored, e.g., within a database or library. The production automated text-based document analyst may be stored in a production analyst library for production document analysis processing. At block 436 the dictionary is also stored as a final dictionary. The method then ends at block 438.

In an exemplary test, a random sample of 100 pathology reports were selected from a repository of 1940 documents. A simple random sampling method was applied. The precision of the correct identification and retrieval of a set of desired contexts within the sample pathology reports was 95% accurate as confirmed by content experts.

In another exemplary test, a sample of 1000 documents were randomly chosen from a larger set of pathology reports used to produce a gold standard for abstracted pathology report data. Of the 1000 documents, the identification of patients as positive for ductal carcinoma in situ (DCIS) using the disclosed system was 90% as confirmed by comparing the sample data precision results with the gold standard data.

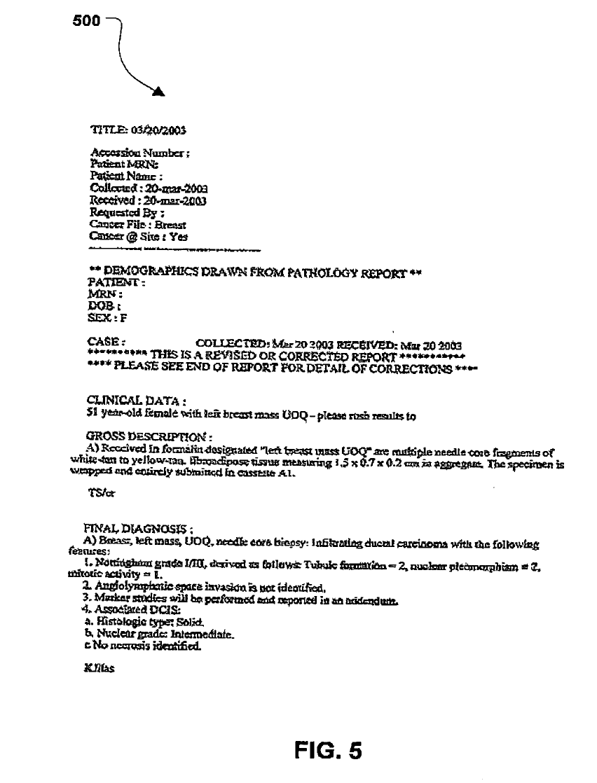

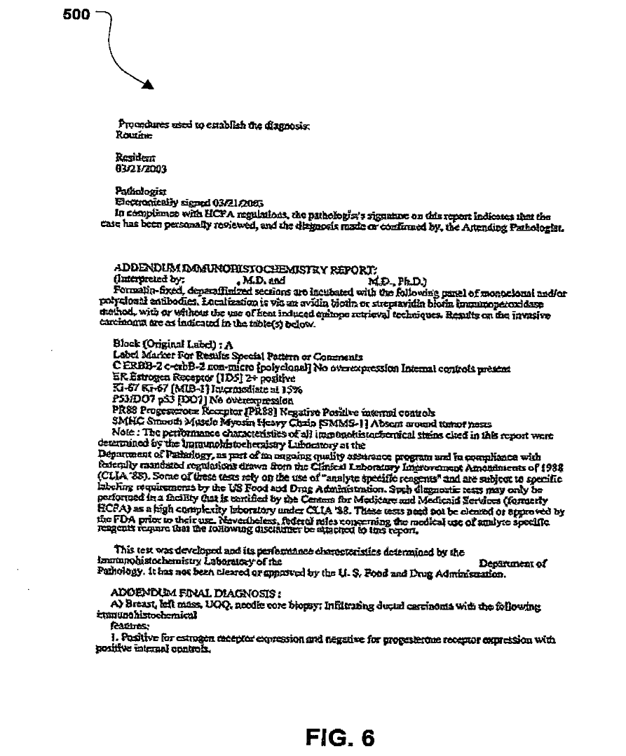

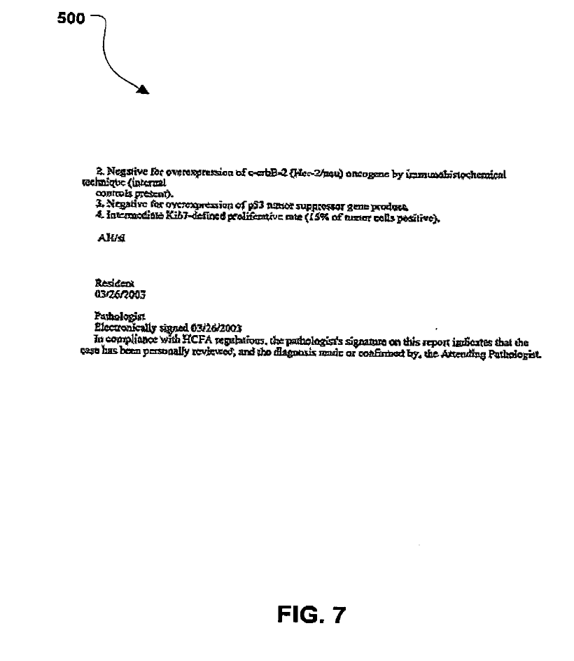

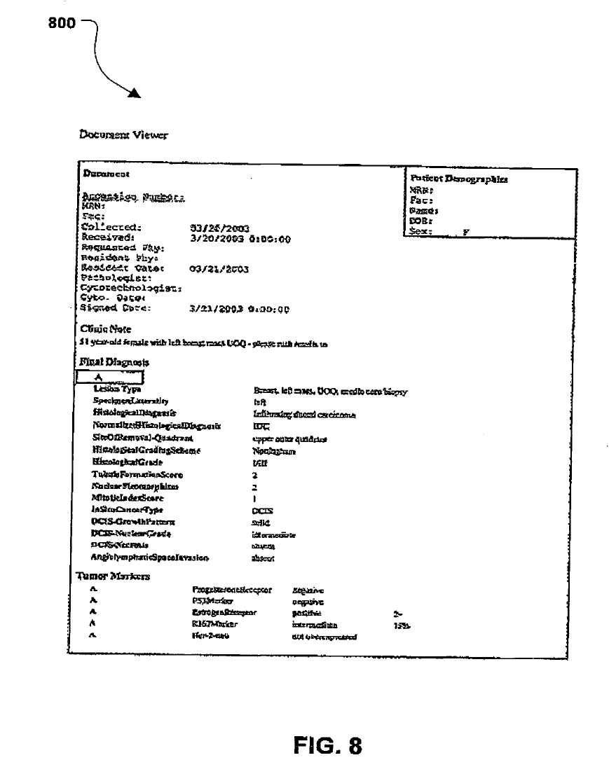

Referring to FIG. 5, FIG. 6, and FIG. 7 an exemplary, non-limiting embodiment of a source document is shown and is generally designated 500. In a particular embodiment, the source document 500 is a medical record, e.g., a pathology report, that contains a fair amount of data to be extracted. In a particular embodiment, the pathology report can be input to the system described in conjunction with FIG. 1. In a particular embodiment, the system 100 (FIG. 1) can create an abstract of the source document 500 using one or more automated text-based document analysts. FIG. 8 illustrates an exemplary, non-limiting embodiment of an abstract, generally designated 800, of the source document 500.

As shown, the abstract 800 includes a plurality of fields that can be filled in using one or more of the automated text-based document analysts. For example, the abstract 800 includes the following fields: MRN, Fac, Collected, Received, Requested Phy, Resident Phy, Resident Date, Pathologist, Cytotechnologist, Cyto. date, and signed date. Further, the abstract 800 also includes additional search fields such as, Lesion Type, Specimen Laterality, Histological Diagnosis, Normalized Histological Diagnosis, Site of Removal Quadrant, Histological Grading Scheme, Histological Grade, Tubule Formation Score, Nuclear Pleomorphism, Mitotic Index Score, In Situ Cancer type, DCIS Growth Pattern, DCIS Nuclear Grade, DCIS Necrosis, and Angiolymphatic Space Invasion.

In a particular embodiment, where possible, each of the search fields is filled after analyzing the source document using the automated text-based document analysts. Fields that do not include matching information within the source document are left blank and may be flagged in order to alert the user.

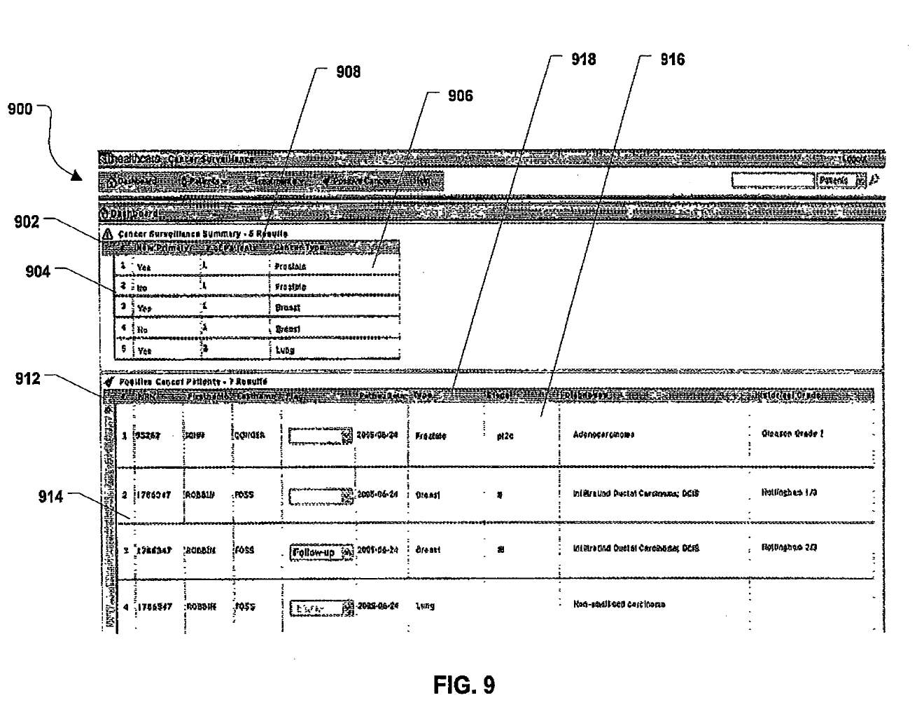

FIG. 9 illustrates an exemplary, non-limiting embodiment of a user interface 900 that can be used to review the data contained in one or more knowledge bundles output by the system 100 illustrated in FIG. 1. In a particular embodiment, the user interface 900 can be used in conjunction with a cancer repository, e.g., a group of source documents related to cancer patients and cancer research and/or associated knowledge bundles including abstracts generated by the system 100.

As shown, the user interface 900 can include a cancer surveillance summary table 902 that includes a plurality of rows 906 and columns 908. In a particular embodiment, the table includes three columns headers 910 that are labeled: “New Primary,” “# of Patients,” and “Cancer Type.” The user interface 900 can also include a positive cancer patients table 912 that includes a plurality of rows 914 and columns 916. As shown, the positive cancer patients table 912 can include nine column headers 918 that are labeled: “MRN,” “Firstname,” “Lastname,” “Flag,” “Patho. Date,” “Type,” “Stage,” “Diagnoses,” and “Historical Grade.”

In a particular embodiment both tables 902, 912 can be filled in based on data extracted from a plurality of source documents that are processed using the system shown in FIG. 1. Any fields in which data is unavailable are left blank.

With the configuration of structure described above, the system and method of extracting knowledge from documents provides a methodology to receive a plurality of documents and quickly analyze the documents to determine the content of the documents. Further, the system and method of managing documents provides an automated system to distill a large amount of documents into computer records that are stored in a smaller, more manageable and usable format for analysis and reporting.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by the law, the scope of the present invention is to be determined by the broadest permissible interpretation of the following claims and their equivalents, and shall not be restricted or limited by the foregoing detailed description.

What is claimed is:

1. A method of managing documents, the method comprising:
receiving a plurality of documents;
normalizing each of the plurality of documents;
categorizing each of the plurality of documents to identify a document type; and
based on the document type, selecting at least one automated text-based document analyst from a library system.

2. The method of claim 1, wherein the library system includes at least a first automated text-based document analyst associated with a first document type and at least a second automated text-based document analyst associated with a second document type.

3. The method of claim 1, further comprising extracting data and associated fields from each of the plurality of documents using the selected automated text-based document analyst.

4. The method of claim 3, further comprising creating a knowledge bundle from the data and associated fields.

5. The method of claim 4, further comprising outputting the knowledge bundle.

6. The method of claim 5, further comprising storing the knowledge bundle in a database.

7. The method of claim 6, further comprising providing access to the database using a user interface.

8. The method of claim 6, further comprising providing access to the database using a client application.

9. The method of claim 1, wherein the plurality of documents are normalized by converting each document into a standard format.

10. The method of claim 1, wherein the document type is a contract and wherein the plurality of documents includes at least one contract.

11. The method of claim 1, wherein the document type is a medical record and wherein the plurality of documents includes at least one medical record.

12. A system for analyzing a plurality of documents, the system comprising:
a normalization module;
a categorization module coupled to the normalization module;
an automated text-based document analyzer coupled to the categorization module; and
a library system coupled to the automated text-based document analyzer, wherein the library system includes at least a first automated text-based document analyst associated with a first document type and at least a second automated text-based document analyst associated with a second document type.

13. The system of claim 12, wherein the automated text-based document analyzer selects at least one automated text-based document analyst from the library system based on a document type identified by the categorization module.

14. The system of claim 12, wherein the automated text-based document analyzer selects at least one automated text-based document analyst from the library system based on a document type received from the normalization module.

15. The system of claim 12, wherein the first automated text-based document analyst and the second automated text-based document analyst are generated based on an output file that results from an automated computer executable build operation performed on a plurality of source documents with respect to at least one target field associated with data to be extracted from the plurality of source documents.

16. The system of claim 12, wherein the normalization module receives a plurality of documents and converts each of the plurality of documents to a standard format.

17. The system of claim 16, wherein the categorization module receives a plurality of standardized documents from the normalization module and wherein the categorization module determines a document type associated with each of the plurality of standardized documents based on the information contained in each of the plurality of standardized documents.

18. The system of claim 12, wherein the automated text-based document analyzer uses at least one automated text-based document analyst to extract a plurality of data and associated fields from a plurality of source documents.

19. The system of claim 18, wherein the automated text-based document analyzer provides a knowledge bundle that is constructed from the plurality of data and associated fields.

20. A system for analyzing a plurality of documents, the system comprising:
a computer readable medium; and
a library system stored within the computer readable medium, wherein the library system includes at least a first automated text-based document analyst associated with a first document type and at least a second automated text-based document analyst associated with a second document type, wherein the first automated text-based document analyst and the second automated text-based document analyst have a data extraction precision rate that is greater than 85 percent.

21. The system of claim 20, wherein the first automated text-based document analyst and the second automated text-based document analyst have a precision rate that is greater than 90 percent.

22. The system of claim 21, wherein the first automated text-based document analyst and the second automated text-based document analyst have a precision rate that is greater than 95 percent.

23. The system of claim 20, wherein at least one automated text-based document analyst is selected from the library system based on a document type.

24. The system of claim 20, further comprising a categorization module that receives a plurality of standardized documents and determines a document type associated with each of the plurality of standardized documents.
